(19) United States
(12) Patent Application Publication
(10) Pub. No.: US 2026/0119775 A1
(43) Pub. Date: Apr. 30, 2026

(54) IC DEVICE MODELING METHOD AND SYSTEM

(71) Applicant: TAIWAN SEMICONDUCTOR MANUFACTURING COMPANY, LTD., Hsinchu (TW)

(72) Inventors: Ju-Yi HUNG, Hsinchu (TW); Chiang-Ting LIAO, Hsinchu (TW); Ya-Chin LIANG, Hsinchu (TW); Ze-Ming WU, Hsinchu (TW)

(21) Appl. No.: 19/086,809

(22) Filed: Mar. 21, 2025

Related U.S. Application Data
(60) Provisional application No. 63/712,633, filed on Oct. 28, 2024.

(51) Int. Cl. G06F 30/398; G06F 119/18

(52) U.S. Cl. CPC G06F 30/398; G06F 2119/18

(57) ABSTRACT

A method of manufacturing an IC includes receiving an IC layout diagram including a first semiconductor volume adjacent to a first conductor volume in a first direction, a second conductor volume extending from the first conductor volume to a second semiconductor volume in the first direction, and an interface including a planar region of each of the first semiconductor volume and the second conductor volume perpendicular to a second direction perpendicular to the first direction, determining an equivalent resistance value of the interface based on one or more dimensional values of the first semiconductor volume or the second conductor volume, and modifying an IC device model corresponding to the IC layout diagram by using the equivalent resistance value.

### PRIORITY CLAIM AND CROSS-REFERENCE

The present application claims the priority of U.S. Provisional Application No. 63/712,633, filed Oct. 28, 2024, which is incorporated herein by reference in its entirety.

### BACKGROUND

The ongoing trend in miniaturizing integrated circuits (ICs) has resulted in progressively smaller devices which consume less power, yet provide more functionality at higher speeds than earlier technologies. Such miniaturization has been achieved through design and manufacturing innovations tied to increasingly strict specifications. Various electronic design automation (EDA) tools are used to generate, revise, and verify designs for semiconductor devices while ensuring that IC structure design and manufacturing specifications are met.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a method of modeling an IC device, in accordance with some embodiments.

FIGS. 2A-2C depict IC layout diagrams/devices, in accordance with some embodiments.

FIG. 3 depicts one or more operations of a method of modeling an IC device, in accordance with some embodiments.

FIG. 4 depicts one or more operations of a method of modeling an IC device, in accordance with some embodiments.

FIG. 5 is a block diagram of an electronic design automation (EDA) system, in accordance with some embodiments.

FIG. 6 is a block diagram of an integrated circuit (IC) manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In various embodiments, a method and/or system include modeling an IC device, e.g., a complementary field-effect transistor (CFET) device, by receiving an IC layout diagram including a first semiconductor volume adjacent to a first conductor volume in a first direction, a second conductor volume extending from the first conductor volume to a second semiconductor volume in the first direction, and an interface including a planar region of each of the first semiconductor volume and the second conductor volume perpendicular to a second direction perpendicular to the first direction, determining an equivalent resistance value of the interface based on one or more dimensional values of the first semiconductor volume and/or the second conductor volume, and using the equivalent resistance value to modify a corresponding IC device model, thereby improving model accuracy with respect to the heterogenous conductor/semiconductor interface compared to other approaches, e.g., those in which a heterogenous conductor/semiconductor interface is bypassed or simplified.

In various embodiments, the method and/or system include determining the equivalent resistance value by using an IC component simulation program to solve for values of resistance network components, the values including the equivalent resistance value, or retrieving the equivalent resistance value from an equivalent resistance value reference, e.g., a table, using the one or more dimensional values, and in some embodiments, generating the equivalent resistance value reference by solving for the component values. In some embodiments, the method and/or system include performing one or more additional operations, e.g., performing a circuit simulation, using the modified IC device model.

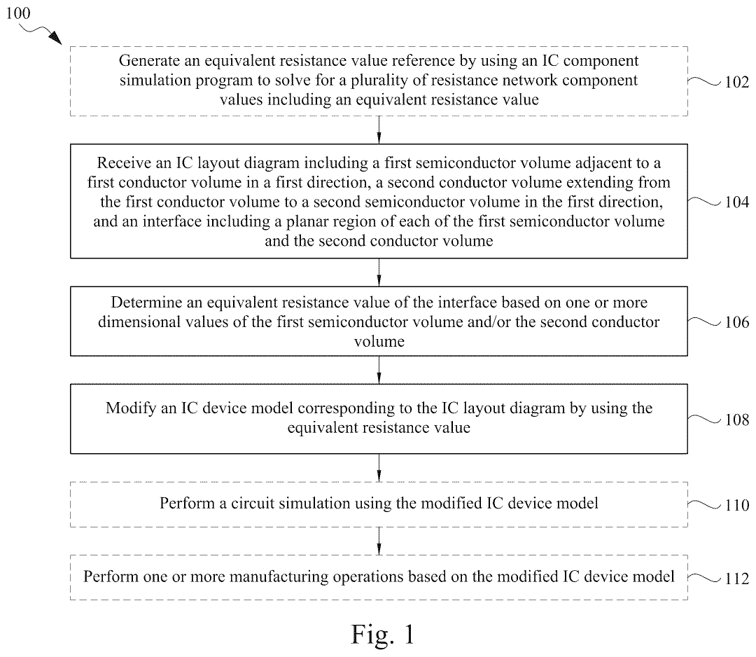

FIG. 1 is a flowchart of a method 100 of modeling an IC device, in accordance with some embodiments. In some embodiments, modeling the IC device includes modeling a transistor, e.g., a CFET, a planar transistor, or a fin field-effect transistor (FinFET). In some embodiments, the transistor is one transistor of a plurality of transistors included in the IC device, non-limiting examples of which include memory circuits, logic devices, processing devices, signal processing circuits, or the like.

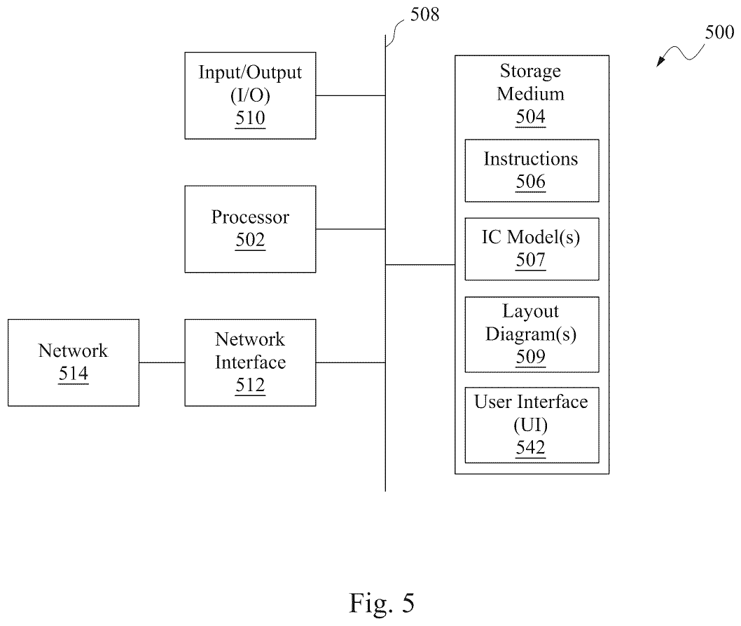

In some embodiments, some or all of method 100 is executed by a processor of a computer. In some embodiments, some or all of method 100 is executed by a processor 502 of an electronic design automation (EDA) system 500, discussed below with respect to FIG. 5.

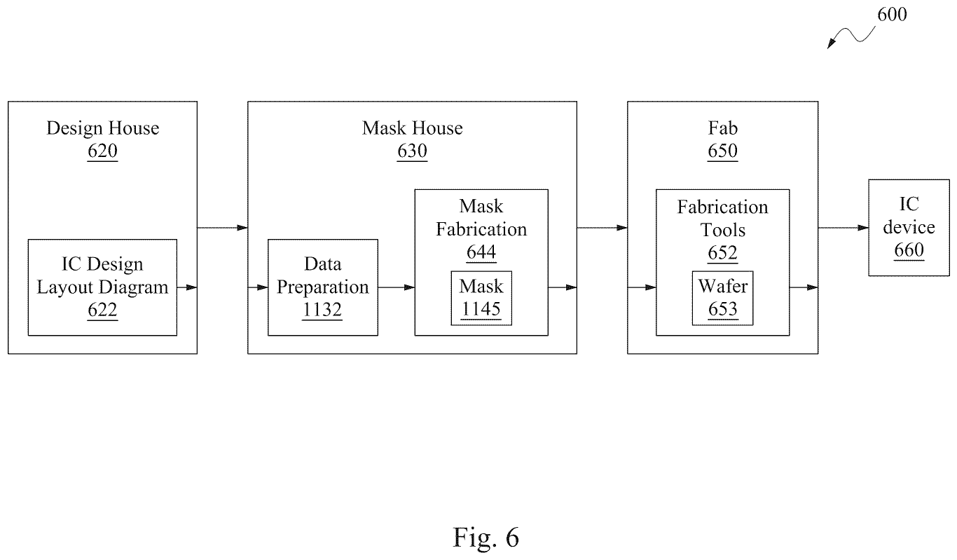

Some or all of the operations of method 100 are capable of being performed as part of a design procedure performed in a design house, e.g., a design house 620 discussed below with respect to FIG. 6.

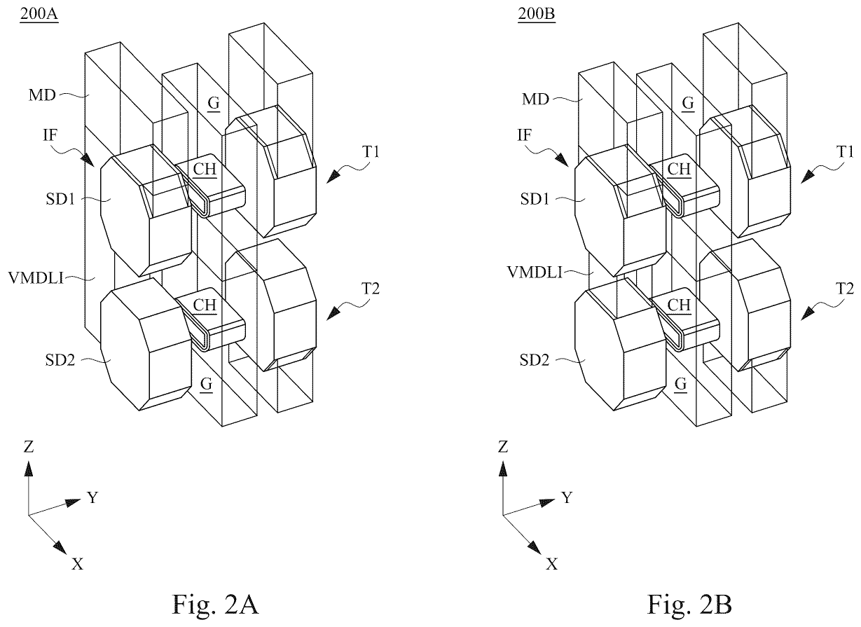

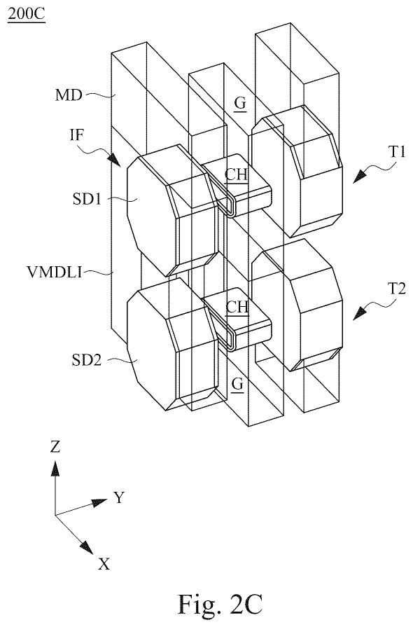

In some embodiments, the operations of method 100 are performed in the order depicted in FIG. 1. In some embodiments, the operations of method 100 are performed in an order other than the order depicted in FIG. 1. In some embodiments, one or more operations are performed before, between, during, and/or after performing one or more operations of method 100. The operations of method 100 are illustrated using FIGS. 2A-4 as discussed below.

Each of the figures herein, e.g., FIGS. 2A-4, is simplified for the purpose of illustration. The figures are views of IC schematics, structures, devices, layout diagrams, and models with various features included and excluded to facilitate the discussion below. In various embodiments, an IC, structure, device, layout diagram, and/or model includes one or more features corresponding to power distribution structures, metal interconnects, contacts, vias, gate structures, source/drain (S/D) structures, active areas, bulk connections, or other transistor elements, isolation structures, or the like, in addition to the features depicted in FIGS. 2A-4. In the discussion below, a given S/D region/structure may refer to a source or a drain, individually or collectively dependent upon the context.

In each of FIGS. 2A-4, reference designators may represent both IC device features and the IC layout features used to at least partially define the corresponding IC device features in a manufacturing process, e.g., the IC manufacturing flow associated with IC manufacturing system 600 discussed below with respect to FIG. 6. Accordingly, each of IC layout diagrams/devices 200A-200C depicted in FIGS. 2A-2C represents a view of both an IC layout diagram 200A-200C and a corresponding IC device 200A-200C.

FIGS. 2A-2C depict corresponding IC layout diagrams/devices 200A-200C and X, Y, and Z directions. IC layout diagrams/devices 200A-200C, also referred to as CFET layout diagrams/devices 200A-200C in some embodiments, are non-limiting examples of IC layout diagrams/devices that include at least one heterogenous conductor/semiconductor interface IF, also referred to as an interface IF in some embodiments.

A conductor volume is an IC layout diagram volume included in a manufacturing process as part of defining a corresponding IC device volume including one or more conductive materials, e.g., copper (Cu), silver (Ag), tungsten (W), titanium (Ti), nickel (Ni), tin (Sn), aluminum (Al), polysilicon, or another metal or material suitable for providing a low resistance electrical connection between IC structure elements, i.e., a resistance level below a predetermined threshold corresponding to one or more tolerance levels of a resistance-based effect on circuit performance.

In some embodiments, a conductor volume includes one or more metal-like defined (MD) layers, e.g., configured as a S/D terminal connection, configured as an interconnect feature, e.g., of a CFET. In some embodiments, a conductor volume is referred to as an MD structure, layer, or volume, an interconnect or interconnect structure, a local interconnect/interconnect structure, an MD interconnect/interconnect structure, a vertical interconnect/interconnect structure, or a vertical MD interconnect/interconnect structure.

In some embodiments, a conductor volume includes the one or more conductive materials configured to have a bias-independent resistance value, e.g., a resistance value that varies within a specified tolerance level over one or more specified bias voltage and/or bias current ranges.

A semiconductor volume is an IC layout diagram volume included in a manufacturing process as part of defining a corresponding IC device volume including one or more semiconductor materials, e.g., silicon (Si), silicon-germanium (SiGe), silicon-carbide (SiC), or the like, a dopant material, e.g., boron (B), aluminum (Al), phosphorous (P), arsenic (As), gallium (Ga), or another material suitable for providing electrical characteristics corresponding to one or more predetermined criteria.

In some embodiments, a semiconductor volume includes one or more epitaxial layers. In some embodiments, a semiconductor volume includes at least one nano-sheet structure, e.g., a continuous volume of one or more layers of one or more semiconductor materials having either n-type or p-type doping. In various embodiments, individual nano-sheet layers include a single monolayer or multiple monolayers of a given semiconductor material.

In some embodiments, a semiconductor volume includes the one or more semiconductor materials configured to have a bias-dependent resistance value, e.g., a resistance value that varies in accordance with a predefined relationship between a specified range of resistance values and one or more specified bias voltage and/or bias current ranges. In some embodiments, a semiconductor volume includes the one or more semiconductor materials configured as a p-type volume or an n-type volume.

In some embodiments, a semiconductor volume corresponds to a front-end-of-line (FEOL) component of a corresponding manufacturing process and a conductor volume corresponds to a middle-of-line (MOL) component of the corresponding manufacturing process.

An interface IF is a geometric feature including one or more two or three dimensional surfaces, e.g., one or more planar regions or curved surfaces, at which a given conductor volume is adjacent to, e.g., contacts, a given semiconductor volume.

In various embodiments, a surface of an interface IF includes a single planar region corresponding to the conductor/semiconductor volumes being adjacent in a single direction, two planar regions corresponding to the conductor/semiconductor volumes being adjacent in two directions, e.g., at a corner of one of the conductor/semiconductor volumes, three planar regions corresponding to the conductor/semiconductor volumes being adjacent in three directions, e.g., one of the conductor/semiconductor volumes partially surrounding the other of the conductor/semiconductor volumes, or four planar regions corresponding to the conductor/semiconductor volumes being adjacent in four directions, e.g., one of the conductor/semiconductor volumes entirely surrounding the other of the conductor/semiconductor volumes. Interface IF including feature geometries other than those discussed above is within the scope of the present disclosure.

As depicted in FIGS. 2A-2C, each of IC layout diagrams/devices 200A-200C includes a conductor volume MD configured as an MD structure, a conductor volume VMDLI configured as an interconnect structure, a semiconductor volume SD1 configured as a nanosheet structure, and a semiconductor volume SD2 configured as a nanosheet structure. In some embodiments, conductor volume MD is referred to as MD structure MD, conductor volume VMDLI is referred to as interconnect structure VMDLI, semiconductor volume SD1 is referred to as epitaxial volume SD1, and/or semiconductor volume SD2 is referred to as epitaxial volume SD2.

In some embodiments, semiconductor volume SD1 is an n-type semiconductor volume and semiconductor volume SD2 is a p-type semiconductor volume or semiconductor volume SD1 is a p-type semiconductor volume and semiconductor volume SD2 is an n-type semiconductor volume.

Each of IC layout diagrams/devices 200A-200C also includes gate regions/structures G, channel regions/structures CH, and additional instances of a conductor volume and a semiconductor volume that are not labeled for the purpose of clarity. The instances of gate regions/structures G, channel regions/structures CH, and conductor and semiconductor volumes are arranged as a transistor T1 overlying a transistor T2 in the Z direction.

Conductor volume MD overlies each of conductor volume VMDLI and semiconductor volume SD1 in the Z direction, semiconductor volume SD1 overlies semiconductor volume SD2 in the Z direction, and conductor volume VMDLI extends from conductor volume MD to semiconductor volume SD2 in the Z direction.

Conductor volume VMDLI is adjacent to and contacts semiconductor volume SD2 along interface IF. In each of IC layout diagrams/devices 200A-200C, interface IF includes multiple surfaces corresponding to the geometries of conductor volume VMDLI and semiconductor volume SD2 as depicted in FIGS. 2A-2C.

To simulate operation of an IC device, e.g., an IC device 200A-200C, a corresponding IC device model can be used based on the corresponding IC layout diagram including interface IF, e.g., IC layout diagram 200A-200C, as discussed below.

At operation 102, in some embodiments, an equivalent resistance value reference, e.g., a table, is generated by using an IC component simulation program to solve for a plurality of resistance network component values including an equivalent resistance value. In some embodiments, using the IC component simulation program includes using one or more of a SPICE® or HSPICE® program.

In some embodiments, generating the equivalent resistance value reference includes generating the equivalent resistance value reference based on one of IC layout diagrams/devices 200A-200C.

The resistive network includes resistors arranged in accordance with a configuration of conductor and semiconductor volumes of an IC device including at least one instance of interface IF discussed above. Each resistor has a resistance value derived from the dimensions and spatial relationships of the IC device features, with one of the resistors being assigned to represent the instance of interface IF and at least one of the resistors being assigned to represent the conductor volume corresponding to interface IF.

For a given IC device configuration including the dimensions and spatial relationships of the IC device features, resistance network component values are solved for each of the resistors of the resistance network including the resistor representing interface IF.

By varying the dimensions and/or spatial relationships of the IC device features and solving for the resistance network component values for each variation, a reference, e.g., table, of resistance values corresponding to interface IF is generated. In some embodiments, the generated resistance values are referred to as equivalent resistance values, equivalent interface resistance values, or size-dependent equivalent resistance values.

Varying the dimensions and/or spatial relationships of the IC device features is based on varying one or more dimensional values of the semiconductor volume and/or the conductor volume corresponding to interface IF. In various embodiments, the one or more dimensional values include one or a combination of a one-dimensional value such as a length, width, and/or height of one or both of the semiconductor/conductor volumes, a two-dimensional value such as an area of a surface of one or both of the semiconductor/conductor volumes, or a three-dimensional value such as a volume of some or all of one or both of the semiconductor/conductor volumes.

The equivalent resistance value reference is thereby generated including the equivalent resistance values referenced to one or more indices corresponding to the various values of the one or more dimensional values used to solve for the equivalent resistance values.

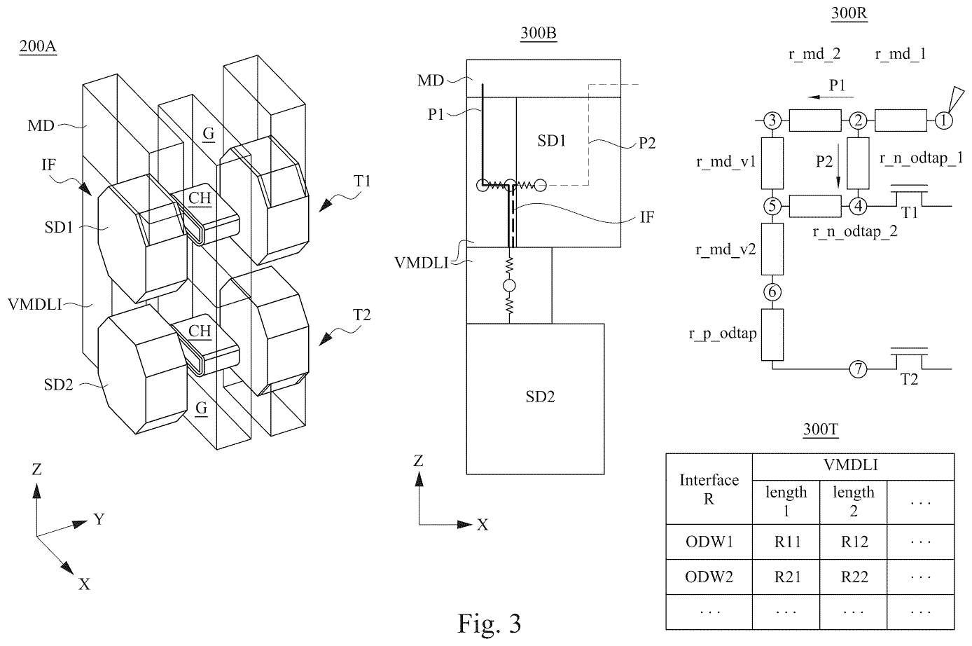

A non-limiting example of generating the equivalent resistance value reference is depicted in FIG. 3, in which a plurality of resistance network component values are solved based on IC layout diagram/device 200A.

As depicted in FIG. 3, IC layout diagram/device 200A is represented by a block diagram 300B in which conductor volume VMDLI is represented as a first segment adjacent to semiconductor volume SD1 in the X direction and a second segment between semiconductor volumes SD1 and SD2 in the Z direction. A path P1 extends from conductor volume MD through the first and second segments of conductor volume VMDLI to semiconductor volume SD2, and a path P2 extends from conductor volume MD through semiconductor volume SD1 to path P1.

Resistance network 300R based on IC layout diagram/device 200A and block diagram 300B includes a resistor r_md_1 representing a portion of conductor volume MD included in each of paths P1 and P2. Resistors r_md_2, r_md_v1, r_md_v2, and r_p_odtap represent path P1 from conductor volume MD to semiconductor volume SD2 being a S/D terminal of transistor T2, and a resistor r_n_odtap_1 represents path P2 from conductor volume MD to semiconductor volume SD1 being a S/D terminal of transistor T1. A resistor r_n_odtap2 represents interface IF between the first segment of conductor volume VMDLI and semiconductor volume SD1.

For a given configuration of IC layout diagram/device 200A including dimensional values and spatial relationships of conductor volume VMDLI and semiconductor volume SD1, an equivalent resistance value of resistor r_n_odtap2 is solvable.

Equivalent resistance value reference 300T, also referred to as equivalent resistance value table in some embodiments, is generated by solving for equivalent resistance value Rxy for each of multiple values of each of x and y. In the embodiment depicted in FIG. 3, equivalent resistance value reference 300T corresponds to x representing a width ODWx of semiconductor volume SD1 in the X direction, and y representing a length of conductor volume VMDLI in the X direction.

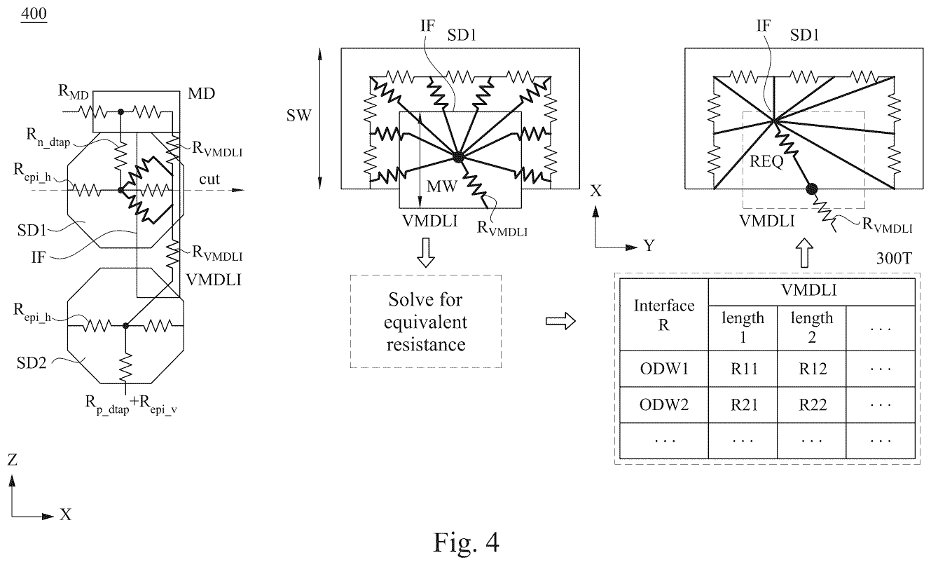

In some embodiments, dimensional values x and y correspond to width SW and length MW depicted in FIG. 4. Other dimensions corresponding to dimensional values x and y are within the scope of the present disclosure.

In some embodiments, generating the equivalent resistance value reference includes storing the equivalent resistance value reference in a storage device, e.g., storage medium 504 discussed below with respect to FIG. 5.

At operation 104, an IC layout diagram is received including a first semiconductor volume adjacent to a first conductor volume in a first direction, a second conductor volume extending from the first conductor volume to a second semiconductor volume in the first direction, and an interface including a planar region of each of the first semiconductor volume and the second conductor volume.

In some embodiments, receiving the IC layout diagram includes receiving the IC layout diagram including semiconductor volume SD1 adjacent to conductor volume MD in the Z direction, conductor volume VMDLI extending from conductor volume MD to semiconductor volume SD2 in the Z direction, and interface IF including one or more planar regions of semiconductor volume SD1 and conductor volume VMDLI as discussed above with respect to FIGS. 2A-2C. In some embodiments, receiving the IC layout diagram includes receiving the IC layout diagram including interface IF including three planar regions as depicted in FIG. 4.

In some embodiments, receiving the IC layout diagram includes receiving the IC layout diagram including each of the first and second semiconductor volumes including a FEOL component of an IC device model, e.g., corresponding to one or more bias-dependent resistance values, and each of the first and second conductor volumes including a MOL component of the IC device model, e.g., corresponding to one or more bias-independent resistance values.

At operation 106, an equivalent resistance value of the interface is determined based on one or more dimensional values of the first semiconductor volume and/or the second conductor volume.

In some embodiments, determining the equivalent resistance value of the interface includes retrieving the equivalent resistance value, e.g., equivalent resistance value Rxy, from an equivalent resistance value reference, e.g., equivalent resistance value table 300T, using one or more dimensional values, e.g., dimensional values x and y as depicted in FIG. 3 or width SW and length MW as depicted in FIG. 4.

In some embodiments, determining the equivalent resistance value of the interface includes performing some or all of operation 102 discussed above such that a resistance network, e.g., resistance network 300R, is solved for the equivalent resistance value., e.g., equivalent resistance value Rxy.

At operation 108, an IC device model corresponding to the IC layout diagram/device is modified by using the equivalent resistance value. In some embodiments, modifying the IC device model includes adding a resistor to the IC device model.

In some embodiments, the IC device model includes first resistors corresponding to the second conductor volume and coupled in series along the first direction between the first conductor volume and the second semiconductor volume and second resistors corresponding to the first semiconductor volume and coupled in series parallel to the planar region and perpendicular to the first direction, and modifying the IC device model includes adding a third resistor having the equivalent resistance value between the first resistors and each of the second resistors.

In some embodiments, modifying the IC device model includes modifying an IC device model 400 as depicted in FIG. 4. IC model 400 is based on IC layout diagram/device 200A discussed above and includes semiconductor volumes SD1 and SD2 and conductor volumes MD and VMDLI arranged accordingly.

Conductor volume MD includes a bias-independent resistor R_{MD}, conductor volume VMDLI includes two instances of a bias-independent resistor R_{VMDLI}, semiconductor volume SD1 includes a bias-independent resistor Rn_dtap and a bias-dependent resistor Repi_h, and semiconductor volume SD2 includes a bias-independent resistor Rp_dtap+Repi_v and bias-dependent resistor Repi_h.

As indicated in the cross-sectional views corresponding to the cut line, semiconductor volume SD1 partially surrounds conductor volume VMDLI such that interface IF includes three planar regions, a first region corresponding to the Y and Z directions, and second and third regions adjacent to the first region and corresponding to the X and Z directions.

Bias-dependent resistors Repi_h corresponding to semiconductor volume SD1 are coupled in series along each of the planar regions of interface IF. Each resistor Repi_h can be considered to be coupled to an instance of resistor R_{VMDLI} of conductor volume VMDLI through a corresponding distributed portion of interface IF as represented by a plurality of resistors that are not labeled for the purpose of clarity.

Based on width SW of semiconductor volume SD1 in the X direction and length MW of conductor volume VMDLI in the X direction, an equivalent resistance value, e.g., equivalent resistance value R11, is determined in accordance with operation 106 discussed above, either by solving for the equivalent resistance or by retrieving the equivalent resistance value from an equivalent resistance reference.

A resistor REQ having the equivalent resistance value is used to replace the plurality of resistors by being coupled between the instance of resistor R_{VMDLI} of conductor volume VMDLI and each of resistors Repi_h, configured as depicted in FIG. 4, and is thereby used to represent interface IF IC device model 400 such that IC device model 400 includes a representation of interface IF usable in an IC device simulation.

The embodiment depicted in FIG. 4 is a non-limiting example provided for the purpose of illustration. Configurations other than that depicted in FIG. 4, e.g., including interface IF including one, two, or four planar regions, are within the scope of the present disclosure.

In some embodiments, modifying the IC device model includes storing the modified IC device model in a storage device, e.g., IC models 507 discussed below with respect to FIG. 5.

At operation 110, in some embodiments, a circuit simulation is performed using the modified IC device model. In some embodiments, performing the circuit simulation includes performing a resistance-capacitance (RC) based simulation, e.g., a QCAP or Coventor simulation.

In some embodiments, performing the circuit simulation includes determining, using the circuit simulation, whether the IC layout diagram complies with a design specification. In some embodiments, performing the circuit simulation includes determining that the IC layout diagram does not comply with the design specification, and based on the determination, modifying the IC layout diagram.

In some embodiments, modifying the IC layout diagram includes storing the modified IC layout diagram in a storage device, e.g., layout diagrams 509 discussed below with respect to FIG. 5.

At operation 112, in some embodiments, one or more manufacturing operations are performed based on the modified IC device model. In some embodiments, performing the one or more manufacturing operations includes generating one or more semiconductor masks and/or fabricating at least one component in a layer of an IC, e.g., by performing one or more lithographic exposures, based on the modified IC device model and/or modified IC layout diagram, e.g., as discussed below with respect to FIG. 6.

By executing some or all of the operations of method 100, an equivalent resistance value of a heterogenous conductor/semiconductor interface is determined based on one or more dimensional values of a first semiconductor volume and/or second conductor volume, and used to modify a corresponding IC device model, thereby improving model accuracy with respect to the interface compared to other approaches, e.g., those in which a heterogenous conductor/semiconductor interface is bypassed or simplified.

In some embodiments, the model accuracy improvements are further facilitated by generating an equivalent resistance value reference by determining the equivalent resistance value by solving for component values including the equivalent resistance value using an IC component simulation program, and retrieving the equivalent resistance value from the equivalent resistance value reference using the one or more dimensional values.

FIG. 5 is a block diagram of EDA system 500, in accordance with some embodiments. Methods described herein of designing IC layout diagrams in accordance with one or more embodiments are implementable, for example, using EDA system 500, in accordance with some embodiments.

In some embodiments, EDA system 500 is a general purpose computing device including a hardware processor 502 and a non-transitory, computer-readable storage medium 504. Storage medium 504, amongst other things, is encoded with, i.e., stores, computer program code 506, i.e., a set of executable instructions. Execution of instructions 506 by hardware processor 502 represents (at least in part) an EDA tool which implements a portion or all of a method, e.g., method 100 of modifying an IC device model described above with respect to FIGS. 1-4 (hereinafter, the noted processes and/or methods).

Processor 502 is electrically coupled to computer-readable storage medium 504 via a bus 508. Processor 502 is also electrically coupled to an I/O interface 510 by bus 508. A network interface 512 is also electrically connected to processor 502 via bus 508. Network interface 512 is connected to a network 514, so that processor 502 and computer-readable storage medium 504 are capable of connecting to external elements via network 514. Processor 502 is configured to execute computer program code 506 encoded in computer-readable storage medium 504 in order to cause IC layout diagram generation system 500 to be usable for performing a portion or all of the noted processes and/or methods. In one or more embodiments, processor 502 is a central processing unit (CPU), a multi-processor, a distributed processing system, an application specific integrated circuit (ASIC), and/or a suitable processing unit.

In one or more embodiments, non-transitory, computer-readable storage medium 504 is an electronic, magnetic, optical, electromagnetic, infrared, and/or a semiconductor system (or apparatus or device). For example, non-transitory, computer-readable storage medium 504 includes a semiconductor or solid-state memory, a magnetic tape, a removable computer diskette, a random access memory (RAM), a read-only memory (ROM), a rigid magnetic disk, and/or an optical disk. In one or more embodiments using optical disks, non-transitory, computer-readable storage medium 504 includes a compact disk-read only memory (CD-ROM), a compact disk-read/write (CD-R/W), and/or a digital video disc (DVD).

In one or more embodiments, non-transitory, computer-readable storage medium 504 stores computer program code 506 configured to cause IC layout diagram generation system 500 (where such execution represents (at least in part) the EDA tool) to be usable for performing a portion or all of the noted processes and/or methods. In one or more embodiments, non-transitory, computer-readable storage medium 504 also stores information which facilitates performing a portion or all of the noted processes and/or methods.

In one or more embodiments, non-transitory, computer-readable storage medium 504 stores IC models 507 of IC device models including such IC device models as disclosed herein, e.g., IC device model 400 discussed above with respect to FIGS. 1-4.

In one or more embodiments, computer-readable storage medium 504 stores layout diagrams 509 including such IC layout diagrams as disclosed herein, e.g., IC layout diagrams 200A-200C discussed above with respect to FIGS. 1-4.

IC layout diagram generation system 500 includes I/O interface 510. I/O interface 510 is coupled to external circuitry. In one or more embodiments, I/O interface 510 includes a keyboard, keypad, mouse, trackball, trackpad, touchscreen, and/or cursor direction keys for communicating information and commands to processor 502.

IC layout diagram generation system 500 also includes network interface 512 coupled to processor 502. Network interface 512 allows system 500 to communicate with network 514, to which one or more other computer systems are connected. Network interface 512 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more IC layout diagram generation systems 500.

IC layout diagram generation system 500 is configured to receive information through I/O interface 510. The information received through I/O interface 510 includes one or more of instructions, data, design rules, libraries of standard cells, and/or other parameters for processing by processor 502. The information is transferred to processor 502 via bus 508. IC layout diagram generation system 500 is configured to receive information related to a UI through I/O interface 510. The information is stored in computer-readable medium 504 as user interface (UI) 542.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC layout diagram generation system 500. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 6 is a block diagram of IC manufacturing system 600, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using manufacturing system 600.

In FIG. 6, IC manufacturing system 600 includes entities, such as a design house 620, a mask house 630, and an IC manufacturer/fabricator (“fab”) 650, that interact with one another in the design, development, and manufacturing cycles and/or services related to manufacturing an IC device 660. The entities in system 600 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 620, mask house 630, and IC fab 650 is owned by a single larger company. In some embodiments, two or more of design house 620, mask house 630, and IC fab 650 coexist in a common facility and use common resources.

Design house (or design team) 620 generates an IC design layout diagram 622. IC design layout diagram 622 includes various geometrical patterns, e.g., one or more of IC layout diagrams 200A-200C discussed above with respect to FIGS. 1-4. The geometrical patterns correspond to patterns of metal, oxide, or semiconductor layers that make up the various components of IC device 660, e.g., one or more of IC devices 200A-200C discussed above with respect to FIGS. 1-4, to be fabricated. The various layers combine to form various IC features. For example, a portion of IC design layout diagram 622 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 620 implements a proper design procedure to form IC design layout diagram 622. The design procedure includes one or more of logic design, physical design or place and route. IC design layout diagram 622 is presented in one or more data files having information of the geometrical patterns. For example, IC design layout diagram 622 can be expressed in a GDSII file format or DFII file format.

Mask house 630 includes data preparation 632 and mask fabrication 644. Mask house 630 uses IC design layout diagram 622 to manufacture one or more masks 645 to be used for fabricating the various layers of IC device 660 according to IC design layout diagram 622. Mask house 630 performs mask data preparation 632, where IC design layout diagram 622 is translated into a representative data file (RDF). Mask data preparation 632 provides the RDF to mask fabrication 644. Mask fabrication 644 includes a mask writer. A mask writer converts the RDF to an image on a substrate, such as a mask (reticle) 645 or a semiconductor wafer 653. The design layout diagram 622 is manipulated by mask data preparation 632 to comply with particular characteristics of the mask writer and/or requirements of IC fab 650. In FIG. 6, mask data preparation 632 and mask fabrication 644 are illustrated as separate elements. In some embodiments, mask data preparation 632 and mask fabrication 644 can be collectively referred to as mask data preparation.

In some embodiments, mask data preparation 632 includes optical proximity correction (OPC) which uses lithography enhancement techniques to compensate for image errors, such as those that can arise from diffraction, interference, other process effects and the like. OPC adjusts IC design layout diagram 622. In some embodiments, mask data preparation 632 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 632 includes a mask rule checker (MRC) that checks the IC design layout diagram 622 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 622 to compensate for limitations during mask fabrication 644, which may undo part of the modifications performed by OPC in order to meet mask creation rules.

In some embodiments, mask data preparation 632 includes lithography process checking (LPC) that simulates processing that will be implemented by IC fab 650 to fabricate IC device 660. LPC simulates this processing based on IC design layout diagram 622 to create a simulated manufactured device, such as IC device 660. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 622.

It should be understood that the above description of mask data preparation 632 has been simplified for the purposes of clarity. In some embodiments, data preparation 632 includes additional features such as a logic operation (LOP) to modify the IC design layout diagram 622 according to manufacturing rules. Additionally, the processes applied to IC design layout diagram 622 during data preparation 632 may be executed in a variety of different orders.

After mask data preparation 632 and during mask fabrication 644, a mask 645 or a group of masks 645 are fabricated based on the modified IC design layout diagram 622. In some embodiments, mask fabrication 644 includes performing one or more lithographic exposures based on IC design layout diagram 622. In some embodiments, an electron-beam (e-beam) or a mechanism of multiple e-beams is used to form a pattern on a mask (photomask or reticle) 645 based on the modified IC design layout diagram 622. Mask 645 can be formed in various technologies. In some embodiments, mask 645 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 645 includes a transparent substrate (e.g., fused quartz) and an opaque material (e.g., chromium) coated in the opaque regions of the binary mask. In another example, mask 645 is formed using a phase shift technology. In a phase shift mask (PSM) version of mask 645, various features in the pattern formed on the phase shift mask are configured to have proper phase difference to enhance the resolution and imaging quality. In various examples, the phase shift mask can be attenuated PSM or alternating PSM. The mask(s) generated by mask fabrication 644 is used in a variety of processes. For example, such a mask(s) is used in an ion implantation process to form various doped regions in semiconductor wafer 653, in an etching process to form various etching regions in semiconductor wafer 653, and/or in other suitable processes.

IC fab 650 is an IC fabrication business that includes one or more manufacturing facilities for the fabrication of a variety of different IC products. In some embodiments, IC Fab 650 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 650 includes wafer fabrication tools 652 configured to execute various manufacturing operations on semiconductor wafer 653 such that IC device 660 is fabricated in accordance with the mask(s), e.g., mask 645. In various embodiments, fabrication tools 652 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 650 uses mask(s) 645 fabricated by mask house 630 to fabricate IC device 660. Thus, IC fab 650 at least indirectly uses IC design layout diagram 622 to fabricate IC device 660. In some embodiments, semiconductor wafer 653 is fabricated by IC fab 650 using mask(s) 645 to form IC device 660. In some embodiments, the IC fabrication includes performing one or more lithographic exposures based at least indirectly on IC design layout diagram 622. Semiconductor wafer 653 includes a silicon substrate or other proper substrate having material layers formed thereon. Semiconductor wafer 653 further includes one or more of various doped regions, dielectric features, multilevel interconnects, and the like (formed at subsequent manufacturing steps).

In some embodiments, a method of manufacturing an IC includes receiving an IC layout diagram including a first semiconductor volume adjacent to a first conductor volume in a first direction, a second conductor volume extending from the first conductor volume to a second semiconductor volume in the first direction, and an interface comprising a planar region of each of the first semiconductor volume and the second conductor volume perpendicular to a second direction perpendicular to the first direction, determining an equivalent resistance value of the interface based on one or more dimensional values of the first semiconductor volume and/or the second conductor volume, and modifying an IC device model corresponding to the IC layout diagram by using the equivalent resistance value. In some embodiments, the IC device model includes first resistors corresponding to the second conductor volume and coupled in series along the first direction between the first conductor volume and the second semiconductor volume and second resistors corresponding to the first semiconductor volume and coupled in series parallel to the planar region and perpendicular to the first direction, and modifying the IC device model includes adding a third resistor having the equivalent resistance value between the first resistors and each of the second resistors. In some embodiments, each of a first resistance value of one or more of the first resistors and the equivalent resistance value includes a bias-independent resistance value of the IC device model and a second resistance value of one or more of the second resistors includes a bias-dependent resistance value of the IC device model. In some embodiments, each of the first and second semiconductor volumes includes a FEOL component of the IC device model and each of the first and second conductor volumes includes a MOL component of the IC device model. In some embodiments, determining the equivalent resistance value of the interface includes retrieving the equivalent resistance value from an equivalent resistance value reference using the one or more dimensional values. In some embodiments, the method includes generating the equivalent resistance value reference by solving, using an IC component simulation program, for a plurality of resistance network component values comprising the equivalent resistance value. In some embodiments, the method includes performing a circuit simulation using the modified IC device model. In some embodiments, performing the circuit simulation comprises performing an RC-based simulation. In some embodiments, performing the circuit simulation includes determining, using the circuit simulation, that the IC layout diagram does not comply with a design specification, and based on the determination, modifying the IC layout diagram. In some embodiments, the method further includes manufacturing the IC based on the IC layout diagram.

In some embodiments, a method of manufacturing an IC device includes receiving an IC layout diagram including a CFET device, wherein the CFET device includes a first conductor volume adjacent to a first epitaxial volume in a first direction, a second conductor volume extending from the first conductor volume to a second epitaxial volume aligned with the first epitaxial volume in the first direction, and an interface including a first planar region of each of the first epitaxial volume and the second conductor volume perpendicular to a second direction perpendicular to the first direction, determining an equivalent resistance value of the interface based on one or more dimensional values of the first epitaxial volume and/or the second conductor volume, and modifying an IC device model corresponding to the IC layout diagram by using the equivalent resistance value. In some embodiments, the IC device model includes first resistors corresponding to the second conductor volume and coupled in series along the first direction between the first conductor volume and the second epitaxial volume and second resistors corresponding to the first epitaxial volume and coupled in series along the first planar region and perpendicular to the first direction, and modifying the IC device model includes adding a third resistor having the equivalent resistance value between the first resistors and the second resistors. In some embodiments, each of a first resistance value of one or more of the first resistors and the equivalent resistance value includes a bias-independent resistance value of the IC device model, and a second resistance value of one or more of the second resistors includes a bias-dependent resistance value of the IC device model. In some embodiments, the interface includes second and third planar regions of each of the first epitaxial volume and the second conductor volume, each of the second and third planar regions is adjacent to first planar region and perpendicular to a third direction perpendicular to each of the first and second directions, and the second resistors corresponding to the first epitaxial volume are coupled in series further along each of the second and third planar regions and perpendicular to the first direction. In some embodiments, determining the equivalent resistance value of the interface includes retrieving the equivalent resistance value from an equivalent resistance value reference using the one or more dimensional values including a width of the first epitaxial volume in the second direction and a length of the second conductor volume in the second direction. In some embodiments, the method includes generating the equivalent resistance value reference by solving, using an IC component simulation program, for a plurality of resistance network component values comprising the equivalent resistance value. In some embodiments, the first epitaxial volume includes one of an n-type or a p-type nanosheet volume, the second epitaxial volume includes the other of the n-type or the p-type nanosheet volume, the first conductor volume comprises an MD volume, and the second conductor volume includes a vertical MD interconnect volume. In some embodiments, the method includes performing an RC-based simulation of the CFET device using the modified IC device model. In some embodiments, the method further includes manufacturing the IC based on the IC layout diagram.

In some embodiments, IC device modeling system includes a processor and a non-transitory, computer readable storage medium including computer program code for one or more programs, the non-transitory, computer readable storage medium and the computer program code being configured to, with the processor, cause the system to receive an IC layout diagram including a first semiconductor volume adjacent to a first conductor volume in a first direction, a second conductor volume extending from the first conductor volume to a second semiconductor volume in the first direction, and an interface including a planar region of each of the first semiconductor volume and the second conductor volume perpendicular to a second direction perpendicular to the first direction, retrieve an equivalent resistance value of the interface from an equivalent resistance value table based on one or more dimensional values of the first semiconductor volume and/or the second conductor volume, and modify an IC device model corresponding to the IC layout diagram by adding a resistor having the equivalent resistance value. In some embodiments, the non-transitory, computer readable storage medium and the computer program code are configured to, with the processor, further cause the system to generate the equivalent resistance value table by solving for a plurality of resistance network component values including the equivalent resistance value by executing an IC component simulation program. In some embodiments, the non-transitory, computer readable storage medium and the computer program code are configured to, with the processor, further cause the system to perform an RC-based simulation using the modified IC device model.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an integrated circuit (IC) device, the method comprising:
receiving an IC layout diagram comprising:
a first semiconductor volume adjacent to a first conductor volume in a first direction;
a second conductor volume extending from the first conductor volume to a second semiconductor volume in the first direction; and
an interface comprising a planar region of each of the first semiconductor volume and the second conductor volume perpendicular to a second direction perpendicular to the first direction;
determining an equivalent resistance value of the interface based on one or more dimensional values of the first semiconductor volume or the second conductor volume; and
modifying an IC device model corresponding to the IC layout diagram by using the equivalent resistance value.

2. The method of claim 1, wherein
the IC device model comprises:
first resistors corresponding to the second conductor volume and coupled in series along the first direction between the first conductor volume and the second semiconductor volume; and
second resistors corresponding to the first semiconductor volume and coupled in series parallel to the planar region and perpendicular to the first direction, and
the modifying the IC device model comprises adding a third resistor having the equivalent resistance value between the first resistors and each of the second resistors.

3. The method of claim 2, wherein
each of a first resistance value of one or more of the first resistors and the equivalent resistance value comprises a bias-independent resistance value of the IC device model, and
a second resistance value of one or more of the second resistors comprises a bias-dependent resistance value of the IC device model.

4. The method of claim 1, wherein
each of the first and second semiconductor volumes comprises a front-end-of-line (FEOL) component of the IC device model, and
each of the first and second conductor volumes comprises a middle-of-line (MOL) component of the IC device model.

5. The method of claim 1, wherein
the determining the equivalent resistance value of the interface comprises retrieving the equivalent resistance value from an equivalent resistance value reference using the one or more dimensional values.

6. The method of claim 5, further comprising:
generating the equivalent resistance value reference by solving, using an IC component simulation program, for a plurality of resistance network component values comprising the equivalent resistance value.

7. The method of claim 1, further comprising:
performing a circuit simulation using the modified IC device model.

8. The method of claim 7, wherein
the performing the circuit simulation comprises performing a resistance-capacitance (RC) based simulation.

9. The method of claim 7, wherein the performing the circuit simulation comprises:
determining, using the circuit simulation, that the IC layout diagram does not comply with a design specification; and
based on the determination, modifying the IC layout diagram.

10. A method of manufacturing an integrated circuit (IC) device, the method comprising:
receiving an IC layout diagram comprising a complementary field-effect transistor (CFET) device, wherein the CFET device comprises:
a first conductor volume adjacent to a first epitaxial volume in a first direction;
a second conductor volume extending from the first conductor volume to a second epitaxial volume aligned with the first epitaxial volume in the first direction; and
an interface comprising a first planar region of each of the first epitaxial volume and the second conductor volume perpendicular to a second direction perpendicular to the first direction;
determining an equivalent resistance value of the interface based on one or more dimensional values of the first epitaxial volume or the second conductor volume; and
modifying an IC device model corresponding to the IC layout diagram by using the equivalent resistance value.

11. The method of claim 10, wherein
the IC device model comprises:
first resistors corresponding to the second conductor volume and coupled in series along the first direction between the first conductor volume and the second epitaxial volume; and
second resistors corresponding to the first epitaxial volume and coupled in series along the first planar region and perpendicular to the first direction, and
the modifying the IC device model comprises adding a third resistor having the equivalent resistance value between the first resistors and the second resistors.

12. The method of claim 11, wherein
each of a first resistance value of one or more of the first resistors and the equivalent resistance value comprises a bias-independent resistance value of the IC device model, and
a second resistance value of one or more of the second resistors comprises a bias-dependent resistance value of the IC device model.

13. The method of claim 11, wherein
the interface further comprises second and third planar regions of each of the first epitaxial volume and the second conductor volume,
each of the second and third planar regions is adjacent to first planar region and perpendicular to a third direction perpendicular to each of the first and second directions, and
the second resistors corresponding to the first epitaxial volume are coupled in series further along each of the second and third planar regions and perpendicular to the first direction.

14. The method of claim 13, wherein
the determining the equivalent resistance value of the interface comprises retrieving the equivalent resistance value from an equivalent resistance value reference using the one or more dimensional values comprising a width of the first epitaxial volume in the second direction and a length of the second conductor volume in the second direction.

15. The method of claim 14, further comprising:
generating the equivalent resistance value reference by solving, using an IC component simulation program, for a plurality of resistance network component values comprising the equivalent resistance value.

16. The method of claim 10, wherein
the first epitaxial volume comprises one of an n-type or a p-type nanosheet volume,
the second epitaxial volume comprises the other of the n-type or the p-type nanosheet volume,
the first conductor volume comprises a metal-like defined (MD) volume, and
the second conductor volume comprises a vertical MD interconnect volume.

17. The method of claim 10, further comprising:
performing a resistance-capacitance (RC) based simulation of the CFET device using the modified IC device model.

18. An integrated circuit (IC) device modeling system comprising:
a processor; and
a non-transitory, computer readable storage medium including computer program code for one or more programs, the non-transitory, computer readable storage medium and the computer program code being configured to, with the processor, cause the system to:
receive an IC layout diagram comprising:
a first semiconductor volume adjacent to a first conductor volume in a first direction;
a second conductor volume extending from the first conductor volume to a second semiconductor volume in the first direction; and
an interface comprising a planar region of each of the first semiconductor volume and the second conductor volume perpendicular to a second direction perpendicular to the first direction,
retrieve an equivalent resistance value of the interface from an equivalent resistance value table based on one or more dimensional values of the first semiconductor volume or the second conductor volume, and
modify an IC device model corresponding to the IC layout diagram by adding a resistor having the equivalent resistance value.

19. The IC device modeling system of claim 18, wherein the non-transitory, computer readable storage medium and the computer program code are configured to, with the processor, further cause the system to:
generate the equivalent resistance value table by solving for a plurality of resistance network component values comprising the equivalent resistance value by executing an IC component simulation program.

20. The IC device modeling system of claim 18, wherein the non-transitory, computer readable storage medium and the computer program code are configured to, with the processor, further cause the system to:
perform a resistance-capacitance (RC) based simulation using the modified IC device model.
